(19) United States
(12) Patent Application Publication
(10) Pub. No.: US 2018/0007596 A1
(43) Pub. Date: Jan. 4, 2018

(54) METHODS, APPARATUSES AND COMPUTER PROGRAMS FOR PUBLISHING UPDATED CONTEXT INFORMATION PERTAINING TO MOBILE TERMINAL THROUGH PUBLISHING/SUBSCRIBE MECHANISM

(71) Applicant: NOKIA SOLUTIONS AND NETWORKS OY, Espoo (FI)

(72) Inventors: Rainer STADEMANN, Berg (DE); Paolo ZANIER, Munich (DE)

(21) Appl. No.: 15/543,414

(22) PCT Filed: Jan. 15, 2015
(86) PCT No.: PCT/EP2015/050643

§ 371 Date: Jul. 13, 2017

(51) Int. Cl. H04W 36/02; H04W 36/00

(52) U.S. Cl. CPC H04W 36/026; H04W 36/0033

(57) ABSTRACT

Certain embodiments generally relate to mobile communications networks, such as, but not limited to, the Universal Mobile Telecommunications System (UMTS) Terrestrial Radio Access Network (UTRAN), Long Term Evolution (LTE) Evolved UTRAN (E-UTRAN), LTE-A, and/or future mobile network technologies, such as, for example 5th Generation (5G). A method may include detecting, at a mobile network entity, that context information pertaining to a mobile terminal has changed. The method may also include publishing updated context information through implementation of a publish/subscribe mechanism.

### BACKGROUND

### Field

Embodiments of the invention generally relate to mobile communications networks, such as, but not limited to, the Universal Mobile Telecommunications System (UMTS) Terrestrial Radio Access Network (UTRAN), Long Term Evolution (LTE) Evolved UTRAN (E-UTRAN), LTE-A, and/or future mobile network technologies, such as, for example 5th Generation (5G).

### Description of the Related Art

Universal Mobile Telecommunications System (UMTS) Terrestrial Radio Access Network (UTRAN) refers to a communications network including base stations, or Node-Bs, and radio network controllers (RNC). UTRAN allows for connectivity between the user equipment (UE) and the core network. The RNC provides control functionalities for one or more Node-Bs. The RNC and its corresponding Node-Bs are called the Radio Network Subsystem (RNS).

Long Term Evolution (LTE) refers to improvements of the UMTS through improved efficiency and services, lower costs, and use of new spectrum opportunities. In particular, LTE is a 3rd Generation Partnership Project (3GPP) standard that provides for uplink peak rates of at least 50 megabits per second (Mbps) and downlink peak rates of at least 100 Mbps. LTE supports scalable carrier bandwidths from 20 MHz down to 1.4 MHz and supports both Frequency Division Duplexing (FDD) and Time Division Duplexing (TDD).

As mentioned above, LTE may also improve spectral efficiency in networks, allowing carriers to provide more data and voice services over a given bandwidth. Therefore, LTE is designed to fulfill the needs for high-speed data and multimedia transport in addition to high-capacity voice support. Advantages of LTE include, for example, high throughput, low latency, FDD and TDD support in the same platform, an improved end-user experience, and a simple architecture resulting in low operating costs. In addition, LTE is an all internet protocol (IP) based network, supporting both IPv4 and Ipv6.

### SUMMARY

One embodiment is directed to a method that may include detecting, at a mobile network entity, that context information pertaining to a mobile terminal has changed. In an embodiment, the method may also include publishing updated context information through implementation of a publish/subscribe mechanism.

In an embodiment, the publishing mobile network entity may include an access point or an access point function.

In an embodiment, the publishing mobile network entity may include a mobility management entity (MME) or a mobility management entity function.

In an embodiment, the publishing network entity may include a mobile gateway or a mobile gateway function.

In an embodiment, the context information may be a terminal context.

In an embodiment, the context information may be a connection context.

Another embodiment is directed to an apparatus that may include at least one processor, and at least one memory including computer program code. The at least one memory and the computer program code may be configured, with the at least one processor, to cause the apparatus at least to detect, at a mobile network entity, that context information pertaining to a mobile terminal has changed. In an embodiment, the at least one memory and the computer program code may be also be configured, with the at least one processor, to case the apparatus at least to publish updated context information through implementation of a publish/subscribe mechanism.

Another embodiment is directed to an apparatus that may include detecting means for detecting, at a mobile network entity, that context information pertaining to a mobile terminal has changed. In an embodiment, the apparatus may also include publishing means for publishing updated context information through implementation of a publish/subscribe mechanism.

Another embodiment is directed to a method that may include subscribing, at a mobile network entity, to context information updates of mobile terminals. In an embodiment, the method may also include receiving the context information updates through implementation of a publish/subscribe mechanism.

In an embodiment, the subscribing mobile network entity may include an access point or an access point function.

In an embodiment, the subscribing mobile network entity may include a mobility management entity (MME) or a mobility management entity function.

In an embodiment, the subscribing network entity may include a mobile gateway or a mobile gateway function.

In an embodiment, the context information may be a terminal context.

In an embodiment, the context information may be a connection context.

In an embodiment, the mobile network entity may subscribe to context information of a subset of mobile terminals, by defining a filter on the context information.

In an embodiment, the filter or a part of the filter is a geo-area and the context information may include geo-coordinates of the mobile terminal or geo-coordinates of a publishing mobile network element.

In an embodiment, the filter or a part of the filter may be a mobile terminal type and the context information may include the type of the mobile terminal.

In an embodiment, the filter or a part of the filter may be an identifier of a provided service and the context information may include the identifier of the service provided to the mobile terminal.

Another embodiment is directed to an apparatus that may include at least one processor, and at least one memory including computer program code. The at least one memory and the computer program code may be configured, with the at least one processor, to cause the apparatus at least to subscribe, at a mobile network entity, to context information updates of mobile terminals. In an embodiment, the at least one memory and the computer program code may also be configured, with the at least one processor, to cause the apparatus at least to receive said context information updates through implementation of a publish/subscribe mechanism.

Another embodiment is directed to an apparatus that may include subscribing means for subscribing, at a mobile network entity, to context information updates of mobile terminals. In an embodiment, the apparatus may also include receiving means for receiving said context information updates through implementation of a publish/subscribe mechanism.

### BRIEF DESCRIPTION OF THE DRAWINGS

For proper understanding of the invention, reference should be made to the accompanying drawings, wherein:

FIG. 1A illustrates a traditional message pattern, according to certain embodiments.

FIG. 1B illustrates a publish/subscribe message pattern, according to certain embodiments.

FIG. 2 illustrates load balancing implemented according to a publish/subscribe pattern, according to certain embodiments.

FIG. 3 illustrates an example apparatus, according to certain embodiments.

FIG. 4 illustrates another example apparatus, according to certain embodiments.

FIG. 5 illustrates a further example apparatus, according to certain embodiments.

FIG. 6 illustrates yet another example apparatus, according to certain embodiments.

FIG. 7 illustrates a method, according to certain embodiments.

FIG. 8 illustrates another method, according to certain embodiments.

### DETAILED DESCRIPTION

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments. Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

Mobile network control plane functions currently communicate using a request-reply pattern. This message pattern applies well for performing transactions between two nodes, such as, for example, to setup or tear down communication sessions. If more nodes are involved, transactions may typically be chained. For this to work, each requestor node needs to know an up and running response node it can send the request to. Further, as nodes often store connection state information (e.g., context), if one of those nodes in the chain fails, connections are lost.

5G networks may be multi-layer, multi-connectivity networks that may involve multiple access points in a single communication session. Further, there may be requirements to support highest reliability, such as, for example, for public safety or vehicular safety applications. Under these conditions, a publish/subscribe mechanism might prove more appropriate than the conventional request-reply pattern to disseminate state information. In fact, the publisher may write the data, such as, for example, connection state, only once, and the messaging system may deliver that data to all subscribers. Moreover, publisher and subscriber may not necessarily directly interact with each other (de-coupling). This allows building the 5G control plane as a loosely coupled and highly reliable distributed actor system.

3GPP is currently specifying dual-connectivity for LTE. Upcoming 5G mobile networks may support multi-connectivity in order to increase throughput, by means of, for example, joint transmission, and/or reliability, including, for example, soft handover, for improving mobility robustness. Multi-connectivity, as referenced herein, refers to a single terminal that can connect to multiple cells (e.g., antennas) at the same time. Cells in the “active set” can belong to the same frequency or different frequencies of the same radio system or to different radio systems. For example, the maximum active set size in 3G macro deployment is 3. Considering that in 5G cell range may get smaller (e.g., Ultra Dense deployments), the number of cells in the active set may likely be higher.

Considering that in 5G the frequency band at which cells will be deployed may also be significantly increasing (e.g., in mmW deployments), the pattern with which cells are added/removed from an active set may be highly unpredictable and can change abruptly in a very short time. Such a situation may be exhibited, for example, when a link disappears because the person holding the device is turning her/his head.

All cells in the active set and some core network elements may need the same terminal and connection state information (i.e., context) in order to enable delivery of user plane data in the most efficient and effective way. Due to mobility of the terminal, radio connectivity to the surrounding cells may be adapted by tearing down sub-optimal connections and setting up new connections to better cells. This re-configuration of connectivity may be performed without interrupting the data transmission or endangering information security. In order to do so, terminal and connection state information may be transferred from currently or previously used access point(s) to the new access point(s), depending on whether multi-connectivity is supported respectively.

Initial terminal context for 5G has not yet been defined; in LTE the initial terminal context includes security information (for encryption and integrity protection), information about the bearer being setup as well as transport domain information (IP address and GTP tunnel endpoint identifier of the mobile gateway).

In LTE, an eNB (e-Node-B) adds information to the initial terminal context; for instance, temporary identifiers (e.g., c-RNTI) and eNB specific security keys.

Connection state information consists of user plane information and statistics (e.g., available capacity on the radio link, amount of data in the buffer, sequence numbers of un-/acknowledged packets). In LTE, an example of such user plane context information is PDP sequence numbers, necessary to avoid packet loss during a handover procedure.

Whenever a network element detects that any part of the terminal and context information changes, an update of the context information needs to be published again. Embodiments may either publish the updated complete context information, including the unchanged part, or embodiments may publish only that part of the context information which has actually changed.

Since there may not yet be a defined architecture for 5G, embodiments assume a traditional LTE-like architecture (e.g., with S1-C interface between an Access Point (AP) and a Mobility Management Entity (MME), and X2 between APs; S1-U between APs and S-GW), initial context information may be transferred from the MME to all APs, which are controlling cells in the active set during connection setup. In addition, initial context information may be exchanged between APs during handovers (assuming independent Radio Resource Control entities to increase reliability).

Further, terminal and connection state context may be distributed even to a wider set of cells than the active set to reduce handover latency by preparing the cells in advance. This extended set of cells could be derived from, for example, neighboring cells information of the cells belonging to the active set. Additionally, if data de-/multiplexing function is performed in a dedicated user plane node, information related to single connection quality may be delivered to this element so that the best usage of available links can be made. Every time a new node is added/removed from the active set, signalling may be needed at least to transfer the connection context between APs. Thus, certain embodiments of the invention make it possible to address at least the problem of distributing and updating in real-time, dynamic state information, such as, for example, context, in the distributed system of 5G mobile network control functions.

Current mobile networks' control plane functions communicate using a request-reply pattern. Considering multi-connectivity, such a messaging pattern implies a message exchange for each node controlling cells in the active set or extended set.

Publish/subscribe is a communication pattern used in distributed systems, where senders of messages, called publishers, do not directly send the messages to the receivers. Instead, messages are published without knowledge of what, if any, subscribers of the messages there may be. Similarly, receivers may subscribe to messages without knowledge of what, if any, publishers there are.

As part of a subscription, the receiver may specify which published messages it wants to receive. It may do so by specifying a filter for the type and/or content of the message. Here the data structure for the message content is denoted as a message type. All messages of the same type exhibit the same data structure for their content. By specification of filters the publish/subscribe system can deliver messages based on their type and/or content between publishers and subscribers. A use case for a filter is for example given when a network element wants to receive context information of mobile terminals located in a certain geographic area. A network entity which publishes the context information of a terminal may include the geo-coordinates of the terminal into the context. Another network entity interested into the context information of mobile terminals in a certain geo-area specifies this area to the publish/subscribe system as a filter for the messages it wants to subscribe to. In consequence the publish/subscribe system forwards the context information accordingly between publishers and subscribers based on the geo-coordinates contained in the context.

Other example use cases applying publish/subscribe messaging middleware may include financial trading, air-traffic control, smart grid management, and other big data applications. One standard developed to address the requirements of the above use cases is Data Distribution Service for Real-Time Systems (DDS), specified by the Object Management Group (OMG). DDS is a machine-to-machine middleware standard that aims to enable scalable, real-time, dependable, high-performance and interoperable data exchanges between publishers and subscribers.

According to certain embodiments of the invention, a publish/subscribe mechanism may be used to distribute context information in advance to access points in the neighborhood of the currently used access point(s). For example, in one embodiment context information may be distributed in advance to an access point, before a connection handover to that access point is initiated. In other embodiments, distribution of terminal context state, including authentication results, from a central network node, such as, for example, an MME, to a set of access points may be used.

In another embodiment, supporting a multi-connectivity scenario, context information of a terminal may be distributed in advance to an access point before a cell of that access point is added to the active set of the terminal. Other methods of distributing context information may also be implemented.

In certain embodiments, the publish/subscribe mechanism may use the geo-coordinates of the publishing access point as a filter criteria for delivering context information to other access points. Thus, they may receive the context, and if subscribed to the context, they may cache it locally. If, due to some reason, such as, for example, terminal movement, interruption of radio connection because of a radio or e-Node-B (eNB) failure, the connection is handed over to a neighbor access point or a new access point is added to the active set, the context may already be available at the new access point(s). Other reasons for handover or change of the active set may also be applicable.

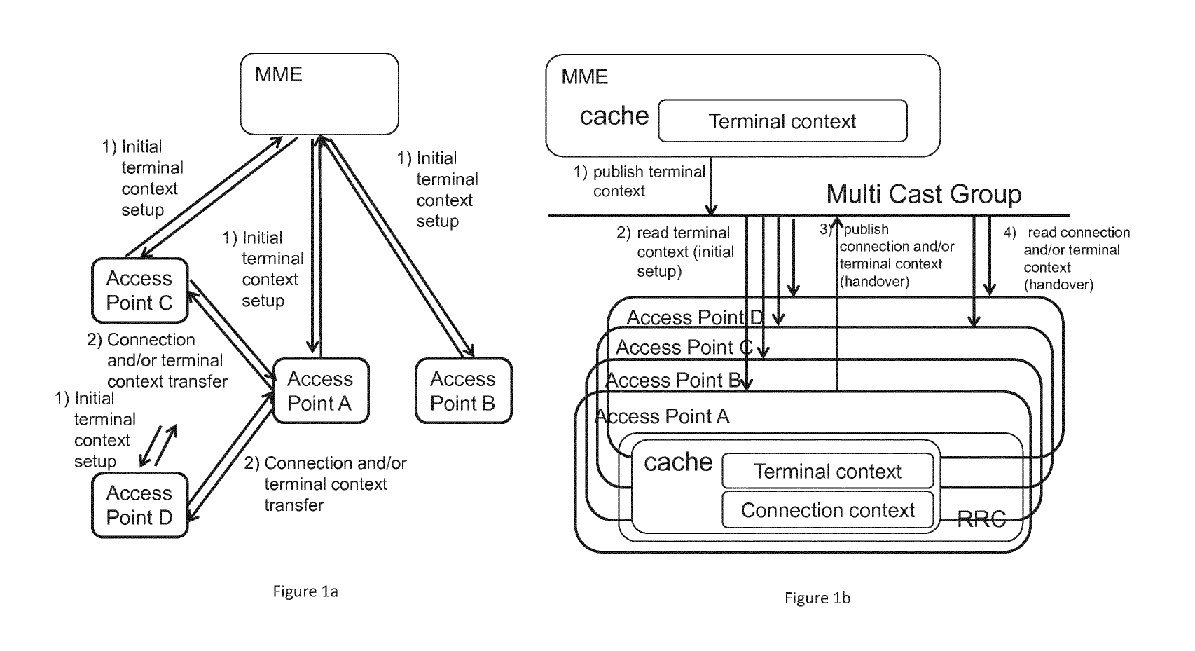

In one setup, the group of cells that are aware of the terminal context is fixed. This group of cells may collectively represent a Tracking Area. This tracking area may represent a filter, to which all cells in the tracking area may have subscribed. For example, in one embodiment, they may have joined a multicast group associated with that tracking area and provided by the publish/subscribe system. In a more advanced setup, terminal measurements and neighbor topology and statistics can be used to continuously optimize the group of cells that need to be aware of the context. For example, cells may decide autonomously whether to subscribe to terminal context information from another cell based on the mentioned information. FIG. 1a illustrates a messaging pattern based on a traditional request-reply mechanism. FIG. 1b illustrates a publish/subscribe pattern, according to certain embodiments. Here, it is assumed that the initial context information may be stored and distributed/published by the MME to APs A-D, and then the connection context information transferred between APs A and C-D. The APs may also publish connection state information. Such connection state information may include connection state information of a terminal.

As illustrated in FIG. 1a, every cell that is part of the active set at setup needs at least two messages for retrieving the terminal context. The same applies to the handover scenario and the context information transfer. Context transfer can happen fairly often when the terminal moves. Moreover, authorization (and initial context setup) may be necessary when certain cells are added to the active set, which belong to a Closed Subscriber Group (CSG), as in this case a CSG-specific authorization is required.

FIG. 1b illustrates a pattern in which the context setup and transfer require less interaction, as compared to that shown in FIG. 1a. For example, in FIG. 1b, context information of a terminal may be stored and/or be available in the cache of the MME. At 1, the MME can publish the terminal context information to multiple APs that are part of the multicast group through implementation of a publish/subscribe mechanism, as described above. At 2, the APs A-D read the published terminal context message from the multi-cast group, store it in their local caches, and read it from the local caches at initial setup. Further, at 3, at least one of the APs can publish connection context and/or terminal context for handover. Finally, at 4, at least one of the APs can read the connection context and/or terminal context for handover from the multi-cast group and store it in its local cache. Publish/subscribe based communication patterns may not only be realized based on the publishing of messages of certain type or with certain content to a multicast group and by joining of subscribers to that multicast group, and optionally by using additionally subscriber side filtering on the messages. More communication bandwidth efficient embodiments may make use of type and/or content sensitive routing of messages between publishers and subscribers.

The publishing mechanism of certain embodiments may allow for high reliability. For example, if an access point fails, the context information of its connections may still be available in the cache of the access points in the neighborhood. Thus, any of these access points (providing coverage to the terminal) may be enabled to take over the connection.

Certain embodiments of the invention may also be applied to any situation where state information of a network element is of interest to other network elements. For example, certain embodiments of the invention may be applied to distribute radio load information for performing self-organizing network (SON) operations, to distribute processor load information of central authenticators to access points for performing load balancing or for distributing tracking area update information.

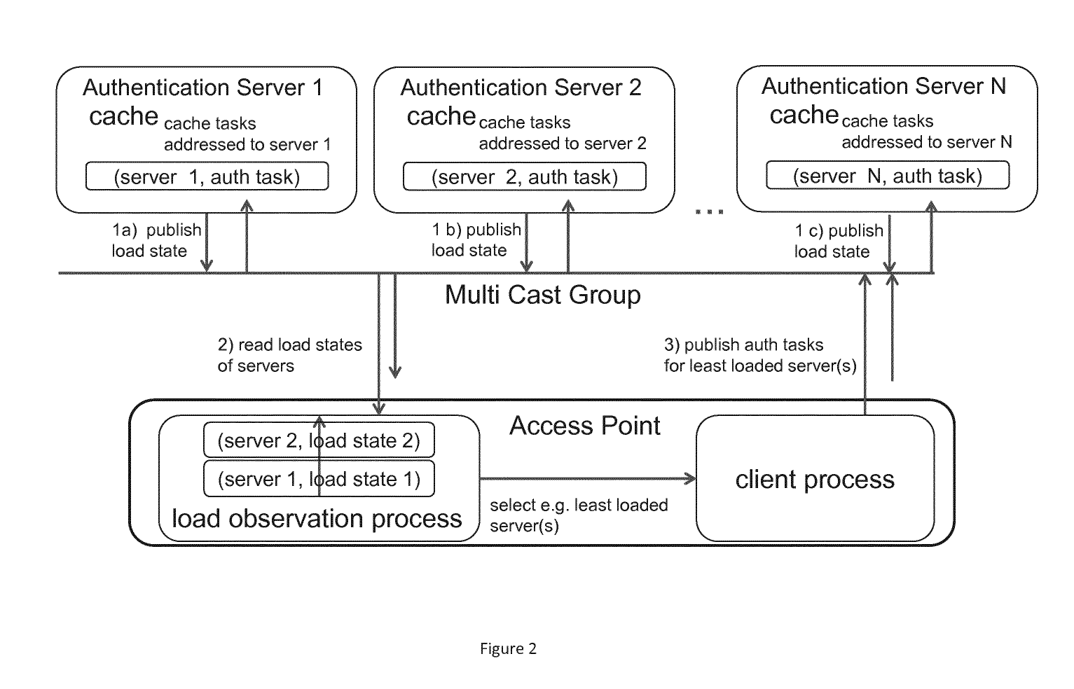

FIG. 2 illustrates an implementation of load balancing for multiple Authorization Servers by using a publish/subscribe mechanism. More specifically, Authentication Servers may publish their own load information at 1a, 1b and 1c, and the APs read it in a load observation process or thread, at 2. This process/thread selects, for example, the least loaded server and sends the identifier (ID) of the least loaded server to another process/thread which is a client of the authentication servers. The client process may publish an authentication task including the ID of the least loaded server. Whenever an AP needs to perform authentication for a terminal, the request can be published for, in one example, the server(s) with lowest load, at 3. Authentication servers read authentication tasks from the multicast group, but filter only for those tasks addressed to them.

According to certain embodiments, the publish/subscribe pattern can be combined with request/reply. For example, in the above case, the client process could also directly send the authentication request via unicast to the selected authentication server, waiting for a unicast reply. However, in this case server and access points need to know their respective unicast addresses.

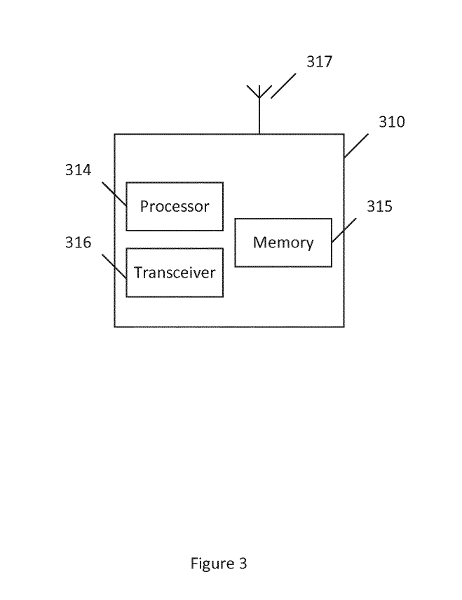

FIG. 3 illustrates an apparatus 310 according to an embodiment. In one embodiment, the apparatus 310 may be a core network entity, such as, for example, an MME or mobile gateway, or a radio network entity such as a base station or access point, or an authentication server, as discussed above in connection with FIGS. 1b and 2. It should be noted that one of ordinary skill in the art would understand that apparatus 310 may include components or features not shown in FIG. 3.

As illustrated in FIG. 3, apparatus 310 includes a processor 314 for processing information and executing instructions or operations. Processor 314 may be any type of general or specific purpose processor. While a single processor 314 is shown in FIG. 3, multiple processors may be utilized according to other embodiments. In fact, processor 314 may include one or more general-purpose computers, special purpose computers, microprocessors, digital signal processors (DSPs), field-programmable gate arrays (FPGAs), central processing units (CPUs) application-specific integrated circuits (ASICs), and processors based on a multi-core processor architecture, as examples. The processor 314 can be implemented as a single controller, or a plurality of controllers or processors.

Apparatus 310 further includes a memory 315, which can independently be any suitable storage device, such as a non-transitory computer-readable medium. The memory 315 may be coupled to processor 314, for storing information and instructions that may be executed by processor 314. Memory 315 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 315 can be comprised of any combination of random access memory (RAM), read only memory (ROM), static storage such as a magnetic or optical disk, or any other type of non-transitory machine or computer readable media. The instructions stored in memory 315 may include program instructions or computer program code that, when executed by processor 314, enable the apparatus 310 to perform tasks as described herein.

Apparatus 310 may also include or is coupled to one or more antennas 317 for transmitting and receiving signals and/or data to and from apparatus 310. Apparatus 310 may further include a transceiver 316 configured to transmit and receive information. For instance, transceiver 316 may be configured to modulate information on to a carrier waveform for transmission by the antenna(s) 317 and demodulates information received via the antenna(s) 317 for further processing by other elements of apparatus 310. In other embodiments, transceiver 316 may be capable of transmitting and receiving signals or data directly.

Processor 314 may perform functions associated with the operation of the apparatus 310 including, without limitation, precoding of antenna gain/phase parameters, encoding and decoding of individual bits forming a communication message, formatting of information, and overall control of the apparatus 310, including process related to management of communication resources.

In an embodiment, memory 315 stores software modules that provide functionality when executed by processor 314. The modules may include, for example, an operating system that provides operating system functionality for apparatus 310. Memory 315 may also store one or more functional modules, such as an application or program, to provide additional functionality for apparatus 310. The components of apparatus 310 may be implemented in hardware, or as any suitable combination of hardware and software.

As mentioned above, according to one embodiment, apparatus 310 may be a network entity, such as, for example, an MME or a mobile gateway. In an embodiment, apparatus 310 may be controlled by memory 315 and processor 314 to detect that context information pertaining to a mobile terminal has changed. Apparatus 310 may be further controlled by memory 315 and processor 314 to publish updated context information through implementation of a publish/subscribe mechanism. In an embodiment, the context information may be published in advance, before a connection handover is initiated, to a topic.

In an embodiment, the publishing mobile network entity may include an access point or an access point function. In another embodiment, the publishing mobile network entity may include a mobility management entity (MME) or a mobility management entity function. Further according to an embodiment, the publishing network entity may include a mobile gateway or a mobile gateway function. Additionally, according to another embodiment, the context information may be a terminal context. Moreover, in an embodiment, the context information may be a connection context.

As further mentioned above, according to another embodiment, apparatus 310 may also be a radio network entity such as a base station or access point. In an embodiment, apparatus 310 may be configured to subscribe to context information updates of mobile terminals. Apparatus 310 may be further controlled by memory 315 and processor 314 to receive the context information updates through implementation of a publish/subscribe mechanism. In an embodiment, the receiving may include receiving the context information updates in advance, before a connection handover is initiated.

In an embodiment, the subscribing mobile network entity may include an access point or an access point function. In another embodiment, the subscribing mobile network entity may include a mobility management entity (MME) or a mobility management entity function. Further, in an embodiment, the subscribing network entity may include a mobile gateway or a mobile gateway function.

According to an embodiment, the context information may be a terminal context. According to another embodiment, the context information may be a connection context. Further, according to an embodiment, the mobile network entity may subscribe to context information of a subset of mobile terminals, by defining a filter on the context information.

Additionally, according to an embodiment, the filter or a part of the filter may be a geo-area and the context information may include geo-coordinates of the mobile terminal or geo-coordinates of a publishing mobile network element.

In an embodiment, the filter or a part of the filter may be a mobile terminal type and the context information may include the type of the mobile terminal. In another embodiment, the filter or a part of the filter may be an identifier of a provided service and the context information may include the identifier of the service provided to the mobile terminal.

As also mentioned above, according to another embodiment, apparatus 310 may be an authentication server. In an embodiment, apparatus 310 may be configured to publish its own load information to one or more access points. In an embodiment, apparatus 310 may also be configured to receive communication from a multicast group of access points.

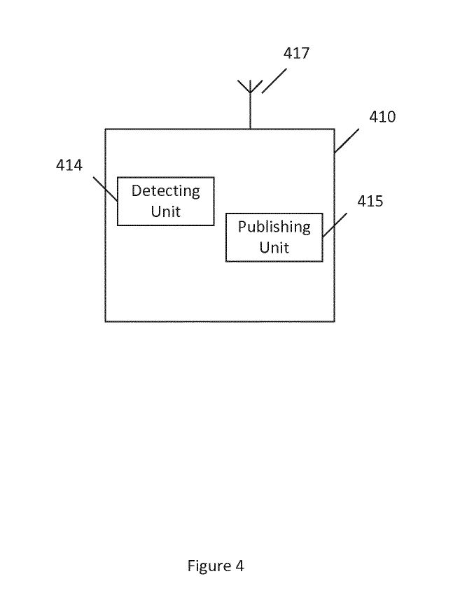

FIG. 4 illustrates an apparatus 410 according to an embodiment. In one embodiment, the apparatus 410 may be a network entity, such as, for example, an MME or mobile gateway, discussed above in connection with FIG. 1b. It should be noted that one of ordinary skill in the art would understand that apparatus 410 may include components or features not shown in FIG. 4.

As illustrated in FIG. 4, apparatus 410 includes a detecting unit 414 that may be configured to detect that context information pertaining to a mobile terminal has changed. Apparatus 410 may also include one or more antennas 417 for transmitting and receiving signals and/or data to and from apparatus 410.

Apparatus 410 also includes a publishing unit 415 that may be configured to publish updated context information through implementation of the publish/subscribe mechanism. In an embodiment, the updated context information may be published in advance, before a connection handover is initiated, to a topic. Further, the publishing unit 415 may be a transceiver or similar device, as described above with respect to apparatus 310, which may further be configured to transmit and receive information. Additionally, apparatus 410 may further include one or more antennas 417 for transmitting and receiving signals and/or data to and from apparatus 410.

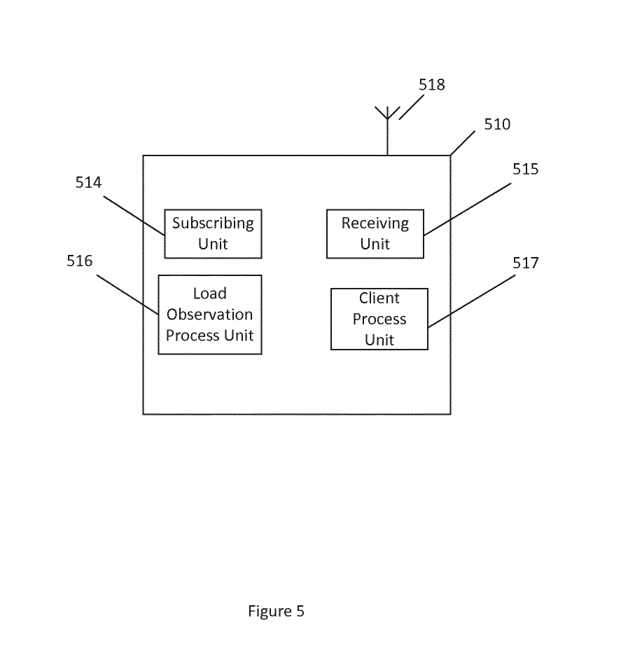

FIG. 5 illustrates an apparatus 510 according to an embodiment. In one embodiment, the apparatus 510 may be a radio network entity such as a base station or access point, discussed above in connection with FIGS. 1b and 2. It should be noted that one of ordinary skill in the art would understand that apparatus 510 may include components or features not shown in FIG. 5.

As illustrated in FIG. 5, apparatus 510 includes a subscribing unit 514 that may be configured to subscribe to context information updates of mobile terminals. The subscribing unit 514 may be a transceiver or similar device, as described above with respect to apparatus 310, which may further be configured to transmit and receive information. Apparatus 510 may also include one or more antennas 518 for transmitting and receiving signals and/or data to and from apparatus 510.

Apparatus 510 also includes a receiving unit 515 that may be configured to receive the context information updates through implementation of a publish/subscribe mechanism. The receiving unit 515 may be a transceiver or similar device, as described above with respect to apparatus 310, which may further be configured to transmit and receive information

Apparatus 510 further includes a load observation process unit 516 that may be configured to read load information of one or more authentication servers in a load observation process or thread that has been published by the authentication server(s). The load observation process unit 516 may also be configured to analyze the load information from the authentication server(s) and select the least loaded sever and send the ID of the least loaded server to another process/thread performing authentication for terminals. Further, the load observation process unit 516 may be a processor or similar device, such as the processor described above with respect to apparatus 310.

Apparatus 510 also includes a client process unit 517 that may be configured to publish an authentication task, which includes the identification of the least loaded server of the authentication servers. The client process unit 517 may be a transceiver or similar device, such as the transceiver described above with respect to apparatus 310, which may further be configured to transmit and receive information.

The subscribing unit 514, receiving unit 515, load observation process unit 516 and client process unit 517 of apparatus 510 may all operate individually and separately with respect to each other. Alternatively, each of the subscribing unit 514, receiving unit 515, load observation process unit 516 and client process unit 517 of apparatus 510 may also each operate in combination with at least one other component of apparatus 510.

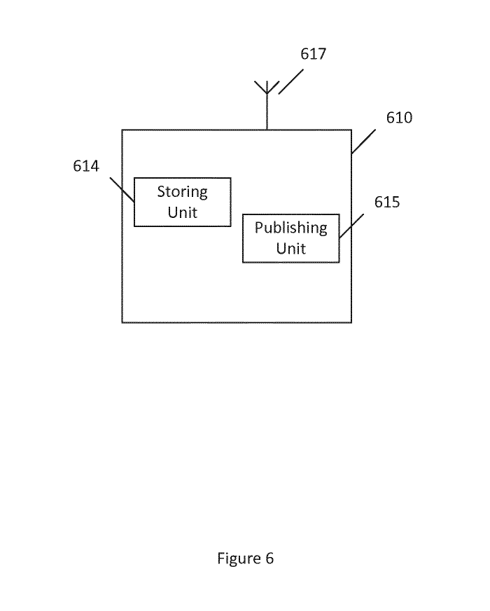

FIG. 6 illustrates an apparatus 610 according to an embodiment. In one embodiment, the apparatus 610 may be an authentication server, such as the authentication server described above in connection with FIG. 2. It should be noted that one of ordinary skill in the art would understand that the apparatus 610 may include components or features not shown in FIG. 6. For example, additional authentication servers may also be included.

As illustrated in FIG. 6, apparatus 610 includes a storing unit 614. The storing unit 614 may be one or more of the memories described above with respect to apparatus 310. For example, the storing unit 614 may be cache memory that may be configured to store tasks addressed to apparatus 610 and load information pertaining to apparatus 610. Apparatus 610 may also include one or more antennas 617 for transmitting and receiving signals and/or data to and from apparatus 610.

Apparatus 610 also includes a publishing unit 615 that may be configured to publish load information pertaining to apparatus 610. The publishing unit 615 may be a transceiver or similar device, as described above with respect to apparatus 310, which may further be configured to transmit and receive information.

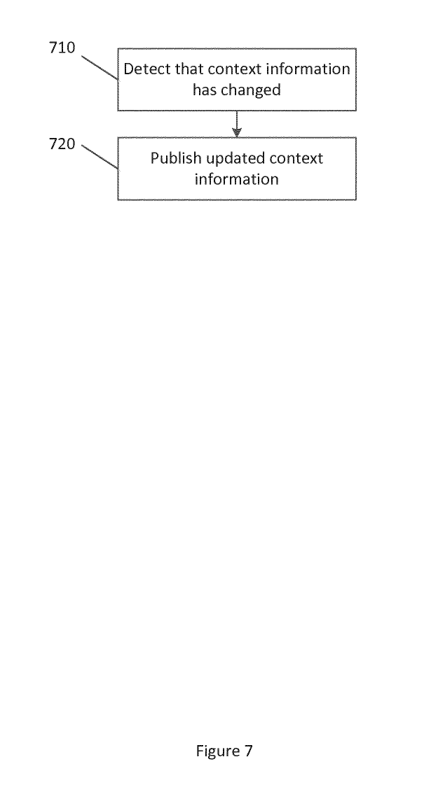

FIG. 7 illustrates an example of a flow diagram of a method, according to one embodiment. In an embodiment, the method of FIG. 7 may be performed by a core network entity, such as an MME or mobile gateway, for example. The method may include, at 710, detecting that context information pertaining to a mobile terminal has changed. The method may further include, at 720, publishing updated context information through implementation of a publish/subscribe mechanism.

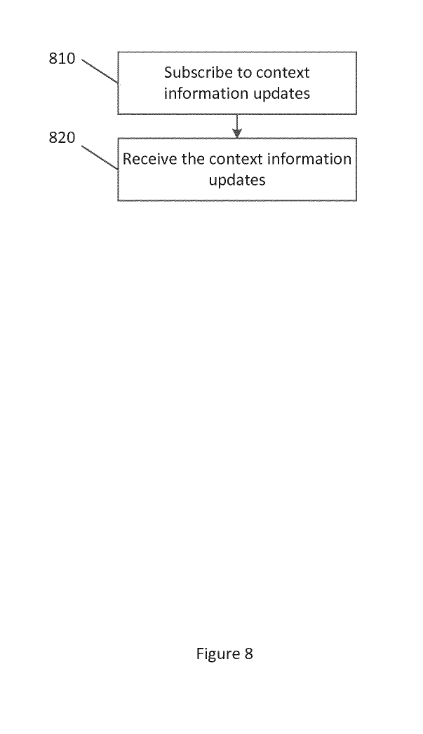

FIG. 8 illustrates an example of a flow diagram of another method, according to an embodiment. In an embodiment, the method of FIG. 8 may be performed by a radio network entity, such as a base station or an access point, for example. The method may include, at 810, subscribing to context information updates of mobile terminals. The method may also include, at 820, receiving the context information updates through implementation of a publish/subscribe mechanism.

In some embodiments, the functionality of any of the methods described herein, such as those illustrated in FIGS. 7 and 8 discussed above, may be implemented by software and/or computer program code stored in memory or other computer readable or tangible media, and executed by a processor. In other embodiments, the functionality may be performed by hardware, for example through the use of ASIC, a programmable gate array (PGA), FPGA, or any other combination of hardware and software.

Embodiments of the invention provide several advantages. For example, a publisher does not need to know the subscribers. Other advantages include the reduction in load on the mobile network control layer. For example, authentication context may be sent only once, instead of multiple times (N times), compared to sending the same information to all neighbors. Additionally, embodiments of the invention can provide a system that can work in a distributed fashion without a central node, allowing it to achieve better resilience compared to a centralized implementation.

In addition, some embodiments are able to support highly reliable and highly available architectures, by replicating state information and storing it distributed in local caches of nodes. Thus, survivability in case of node or transport network failures is increased. Embodiments also support low latency handover and connection re-configuration by in-advance early state transfer. Further, certain embodiments are able to support a loosely coupled architecture, as messages are addressed to multicast groups, not directly to other network nodes. This may increase expandability and scalability as new network nodes can be transparently added, such as, for example, to scale-out or to add even new functionality.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### Glossary

3GPP 3rd Generation Partnership Project
5G 5th Generation
AP Access Point
ASIC Application-Specific Integrated Circuits
CPU Central Processing Unit
CSG Closed Subscriber Group
DDS Data Distribution Service
DSP Digital Signal Processor
eNB E-node-B
E-UTRAN Evolved UTRAN
FDD Frequency Division Duplexing
FPGA Field-Programmable Gate Arrays
IP Internet Protocol
LTE Long Term Evolution
LTE-A Long Term Evolution Advanced
Mbps Megabits Per Second
MME Mobility Management Entity
OMG Object Management Group
PGA Programmable Gate Array
RAM Random Access Memory
RNC Radio Network Controllers
RNS Radio Network Subsystem
ROM Read Only Memory
SON Self-Organizing Networks
TDD Time Division Duplexing
UE User Equipment
UMTS Universal Mobile Telecommunications System
UTRAN Universal Terrestrial Radio Access Network

1. A method, comprising:
detecting, at a mobile network entity, that context information pertaining to a mobile terminal has changed, and
publishing updated context information through implementation of a publish/subscribe mechanism.

2. The method of claim 1, wherein the publishing mobile network entity comprises an access point or an access point function.

3. The method of claim 1, wherein the publishing mobile network entity comprises a mobility management entity (MME) or a mobility management entity function.

4. The method of claim 1, wherein the publishing network entity comprises a mobile gateway or a mobile gateway function.

5. The method of claim 1, wherein the context information is a terminal context.

6. The method of claim 1, wherein the context information is a connection context.

7. An apparatus comprising:
at least one processor; and
at least one memory including computer program code,
wherein the at least one memory and the computer program code are configured, with the at least one processor, to cause the apparatus at least to
detect, at a mobile network entity, that context information pertaining to a mobile terminal has changed, and
publish updated context information through implementation of a publish/subscribe mechanism.

8. (canceled)

9. The apparatus of claim 7, wherein the publishing mobile network entity comprises an access point or an access point function.

10. The apparatus of claim 7, wherein the publishing mobile network entity comprises a mobility management entity (MME) or a mobility management entity function.

11. The apparatus of claim 7, wherein the publishing network entity comprises a mobile gateway or a mobile gateway function.

12. The apparatus of claim 7, wherein the context information is a terminal context.

13. The apparatus of claim 7, wherein the context information is a connection context.

14. (canceled)

15. A method, comprising:
subscribing, at a mobile network entity, to context information updates of mobile terminals; and
receiving said context information updates through implementation of a publish/subscribe mechanism.

16.-20. (canceled)

21. The method according to claim 15, wherein the mobile network entity subscribes to context information of a subset of mobile terminals, by defining a filter on the context information.

22. The method according to claim 15, wherein the filter or a part of the filter is a geo-area and the context information comprises geo-coordinates of the mobile terminal or geo-coordinates of a publishing mobile network element.

23. The method according to claim 15, wherein the filter or a part of the filter is a mobile terminal type and the context information comprises the type of the mobile terminal.

24. The method according to claim 15, wherein the filter or a part of the filter is an identifier of a provided service and the context information comprises the identifier of the service provided to the mobile terminal.

25. An apparatus, comprising:
at least one processor; and
at least one memory including computer program code,
wherein the at least one memory and the computer program code are configured, with the at least one processor, to cause the apparatus at least to
subscribe, at a mobile network entity, to context information updates of mobile terminals; and
receive said context information updates through implementation of a publish/subscribe mechanism.

26.-31. (canceled)

32. The apparatus according to claim 25, wherein the mobile network entity subscribes to context information of a subset of mobile terminals, by defining a filter on the context information.

33. The apparatus according to claim 25, wherein the filter or a part of the filter is a geo-area and the context information comprises geo-coordinates of the mobile terminal or geo-coordinates of a publishing mobile network element.

34. The apparatus according to claim 25, wherein the filter or a part of the filter is a mobile terminal type and the context information comprises the type of the mobile terminal.

35. The apparatus according to claim 25, wherein the filter or a part of the filter is an identifier of a provided service and the context information comprises the identifier of the service provided to the mobile terminal.

36. (canceled)
